(19) United States
(12) Patent Application Publication
(10) Pub. No.: US 2010/0255170 A1
(43) Pub. Date: Oct. 7, 2010

(54) COLD STABILIZATION OF WINE

(76) Inventor: Mario LOPEZ, Frouzins (FR)

Correspondence Address: The BOC Group, Inc., 575 MOUNTAIN AVENUE, MURRAY HILL, NJ, 07974-2082, US

(21) Appl. No.: 12/721,779

(22) Filed: Mar. 11, 2010

(30) Foreign Application Priority Data
Apr. 2, 2009 (EP) 09004893.5

(51) Int. Cl. C12G 1/12; A23L 3/36

(52) U.S. Cl. 426/524; 99/467

(57) ABSTRACT

A process and apparatus are provided for the cold stabilization of wine by chilling the wine in a tank and supplying a cryogen to the wine in the tank. CO₂ may also be added to the wine. Parameters of the tank and wine are monitored for adjusting cooling of the wine in the tank.

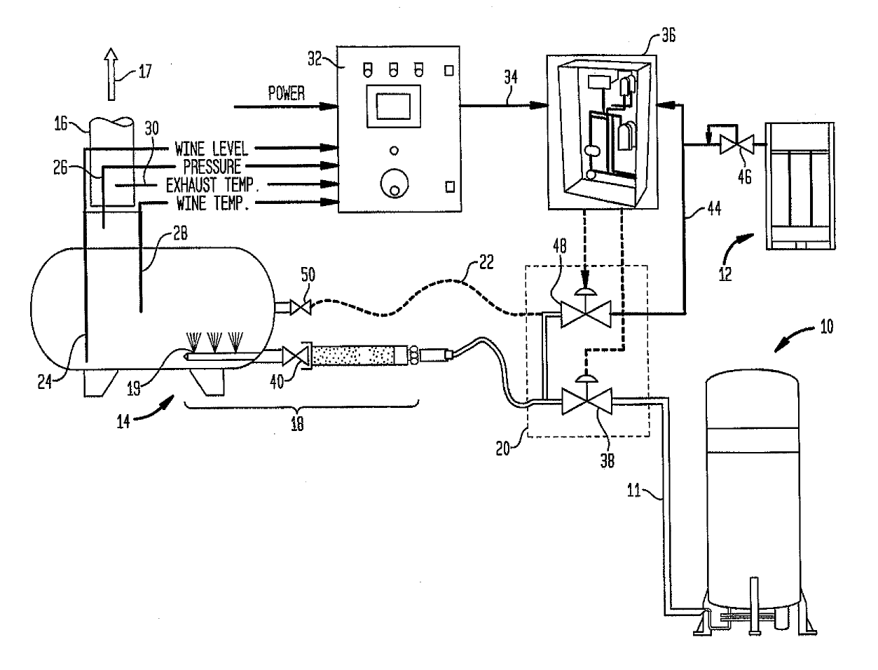

Tartaric acid (tartar) is a compound found naturally in grapes. After bottling wine, the tartaric acid can crystallize in the bottle forming so-called “wine diamonds”. Some customers perceive the presence of the crystals in wine as an indication of poor quality; although it is perfectly natural. Many wineries treat wine before bottling with a process called cold stabilization to avoid formation of crystals in the bottle. Cold stabilization forces crystals of tartaric acid to precipitate as the temperature of wine is reduced to around minus 4° C. in large processing vessels. This is done by mechanically chilling a heat transfer fluid (typically ethylene glycol and water) which in turn is used to cool the wine in the vessel indirectly. The use of a submerged coil or a jacket is disclosed in DE 30 25 677 A1. The treatment time can be reduced to 1.5 to 2 hours by this mechanical cooling.

Some markets prohibit the use of ethylene glycol because it is toxic and can contaminate wine in the event of a leak of the cooling coil or jacket. Eliminating ethylene glycol and many other heat transfer fluids forces winemakers to use simple water for cooling. This limits the temperature they can use for cooling to about 0° C. And this extents the time for cooling up to weeks.

The use of fluorocarbons for refrigerant is possible but shows the drawback of a global warming potential of these substances.

DE-PS 851 041 describes the stabilization of wine by cooling. In its introduction it discloses the precipitation of tartar by introducing solid carbonic acid into the wine in an open vessel. This results in a considerable loss of flavors.

Object of the invention is to propose an alternative process for cold stabilization of wine not using fluorocarbons.

This object is solved by a process with the steps of claim 1. Embodiments of the invention are subjects of the dependent claims.

Core of the invention is the use of a cryogene liquid which brings a lot of cold in the wine stored in a closed tank. The invention replaces or supplements mechanical cooling with a reliable, more intense and lower global warming potential option for cold stabilization.

The invention has the following advantages:

In some markets power is unreliable so the cold stabilization process is often interrupted; extending the process for weeks, but this does not occur with the cryogen process of the present embodiments.

The use of an inert cryogen for cooling has the added effect of removing dissolved oxygen from the wine and protecting the wine from further oxygen exposure just before bottling; improving quality and potentially reducing the use of sulfur dioxide.

The use of fluorocarbons for refrigerant is replaced with cryogen which either has no global warming potential or a very low global warming potential compared to other refrigerants.

The use of cryogen provides a reliable backup for cooling in the event of failure of the mechanical cooling equipment.

In some wineries, the cold stabilization process is a bottleneck in their process; delaying the bottling process. The invention offers the ability to increase the rate of cooling; shortening the time needed for the cold stabilization process.

One embodiment of the invention is further shown by means of the drawing FIGURE. The FIGURE shows a storage standing tank or vessel 10 for nitrogen in liquid state, a cylinder bundle 12 for carbon dioxide and a tank 14 for the wine. The tank 14 includes an exhaust 16. The tank is arranged with a lance 18 for supplying the liquid nitrogen from the storage tank 10. A line 11 for the cryogen extends from the tank 10 to the wine tank 14. A portion of the lance 18 disposed inside the wine tank 14 includes nozzles 19. A manifold 20 is provided for regulating the amount of the nitrogen and/or the amount of carbon dioxide fed to the tank 14. With dotted line 22 a direct injection is shown as a possible alternative for supplying carbon dioxide to the tank 14. The wine tank 14 is equipped with measuring equipment including a liquid gauge 24 for the wine level, a manometer 26 for the pressure and two thermometers 28, 30 for the wine (28) and one for the exhaust (30) temperatures. The measuring equipment transfers its values to an electrical cabinet 32, where the values are used for generating and emitting an electrical signal 34 to a pneumatic cabinet 36 to regulate or steer the amount of liquid nitrogen and/or gaseous CO₂ to the tank 14.

The closed tank 14 or vessel needs to have an adequately sized exhaust 16 opening to allow cryogen vapors indicated by arrow 17 to escape from the vessel 14 without increasing the pressure above the allowable working pressure.

The invention includes a control system of the electrical cabinet 32 to monitor the temperature of the wine during the cooling process and to stop the flow of cryogen when the temperature reaches the set point which is in the range of 5 to minus 10° C.; preferably minus 4° C. is an accurate value.

In the preferred embodiment, the cryogenic liquid is nitrogen. Nitrogen is inexpensive and has a high cooling capacity. The temperature of liquid nitrogen is very low so a relative small amount of liquid nitrogen yields a high cooling power.

The liquid nitrogen can be supplied into the tank 14 by one or a plurality of valves 38, 40 which are specialized for feeding cool media or cryogenics into liquids in food applications. Essentially for the use in food applications is the hygienic standard which must be kept high. In an alternative there can be used so called LIX Shooters®, distributed from Linde AG in Munich, Germany. Another embodiment is the use of a special cooling or chilling lance 18 which supplies the liquid directly into the tank 14.

The valves 38, 40 or the lance 18 should be arranged in a lower part of the tank 14, as shown in the FIGURE for example, for resulting in very intimate mixing of the cryogen liquid with the wine for cooling it.

In one embodiment liquid nitrogen is used to cool the wine in tandem with the mechanical cooling system. Mechanical cooling is lower in costs than cryogen cooling, but the physical properties of the heat transfer fluid limit the rate of cooling and the target temperature. Wineries can combine the lower cost cooling available mechanically with the intensity of cooling offered by cryogens to optimize the process. When this parallel process is made, heat exchangers (not shown) are necessary inside the tank 14 or at least at the shell of the tank.

In another embodiment the invention can be designed with the capacity to provide all the cooling power needed to carry out the process, however, under normal circumstances operated at a lower capacity unless the mechanical system cannot be used due to loss of power or other failure. Therefore, all refrigerating capacity can be applied by inserting of the cryogen liquid. This process is nearly independent from outer energy sources and can be made in very short time.

In another embodiment, the invention includes a connection 44 to the CO₂ supply 12 to provide for a final step to replenish CO₂ that may have been removed from the wine during the cooling process by nitrogen. The sparging of nitrogen through the wine leads to an inavoidable loss of the natural carbon dioxide of the wine. With this option the carbon dioxide loss can be compensated by adding the gaseous CO₂. Valves 46, 48 control flow of the CO₂ through the line 44 and the dotted line 22 to the tank 14. A valve 50 is provided to control the direct injection of the CO₂ into the tank 14.

What is claimed is:

1. A process for cooling wine, comprising supplying a cryogen in a tank in which the wine is disposed.

2. The process according to claim 1, wherein the cryogen comprises nitrogen.

3. The process according to claim 1, wherein the cryogen supplied is selected from liquid cryogen or gaseous cryogens.

4. The process according to claim 1, wherein the supplying the cryogen is to a lower part of the tank.

5. The process according to claim 1, further comprising supplying CO₂ to the tank.

6. The process according to claim 5, wherein the supplying the CO₂ is done concurrently with the supplying the cryogen.

7. The process according to claim 5, wherein the supplying the CO₂ is done sequentially with the supplying the cryogen.

8. The process according to claim 5, further comprising measuring parameters of the tank and the wine in the tank for determining an amount of cryogen and CO₂ to supply to the wine.

9. The process according to claim 8, wherein the parameters measured include an amount of wine in the tank, a pressure in the tank, a temperature of the wine in the tank, and a temperature of exhaust from the tank.

10. An apparatus for cooling wine, comprising a tank for holding the wine and a cryogen feed member connected to the tank to supply cryogen to the wine in the tank.

11. The apparatus according to claim 10, wherein the cryogen feed member comprises a lance constructed to be inserted into the wine in the tank.

12. The apparatus according to claim 11, wherein the lance comprises nozzles for spraying the cryogen into the wine.

13. The apparatus according to claim 10, further comprising a CO₂ feed member in communication with an interior of the tank.

14. The apparatus according to claim 13, further comprising a control assembly in communication with the wine and the tank for supplying cryogen and CO₂ to the tank responsive to parameters of the wine and the tank.

15. The apparatus according to claim 10, wherein the cryogen comprises nitrogen.

16. The apparatus according to claim 10, wherein the cryogen supplied is selected from liquid cryogen or gaseous cryogen.

17. The apparatus according to claim 10, wherein the cryogen feed member is connected to a lower part of the tank.

18. The apparatus according to claim 10, wherein the tank is closed and comprises an exhaust to control escape of vapors from the tank.
